(19) United States
(12) Patent Application Publication
(10) Pub. No.: US 2006/0095326 A1
(43) Pub. Date: May 4, 2006

(54) Sales tool using demographic content to improve customer service

(76) Inventors: Karandeep Sandhu, Mountain View, CA (US); Saurabh Khetrapal, Palo Alto, CA (US); Arvin Patel, Sunnyvale, CA (US)

Correspondence Address: IPSG, P.C., P.O. BOX 700640, SAN JOSE, CA, 95170-0640, US

(21) Appl. No.: 11/242,214

(22) Filed: Sep. 30, 2005

Related U.S. Application Data
(63) Continuation-in-part of application No. 11/021,838, filed on Dec. 24, 2004.
(63) Continuation-in-part of application No. 10/853,977, filed on May 25, 2004.

(51) Int. Cl. G06Q 30/00

(52) U.S. Cl. 705/14

(57) ABSTRACT

A sales tool for improving customer service comprises a computer system including a processor, program, and network communication interface, wherein the computer system is configured to receive a geographic identifier, and configured to retrieve content relevant to the geographic identifier and provide the content to an operator. In one embodiment, an identifier structure is capable of providing a geographic identifier to the computer system. In aspects of the invention, the geographic identifier is a zip code, a customer's telephone number where the geographic identifier is a geographic area corresponding to the telephone number, and a customer's internet address where the geographic identifier is a geographic area corresponding to the internet protocol address. In other aspects, the computer system is configured to retrieve content from internet databases relevant to the geographic identifier. Advantages of the invention include the ability to provide improved sales and customer service.

### RELATED APPLICATIONS

This is a continuation-in-part of Ser. No. 11/021,838 filed Dec. 24, 2004 and Ser. No. 10/853,977 filed May 25, 2004, incorporated herein by reference.

### FIELD

The invention relates to the general field of sales tools for improving customer service. In particular, the invention employs a computer structure that includes demographic and other content in order to improve customer service, interest and sales.

### BACKGROUND

Establishing a positive customer relationship is important for building trust and satisfaction in a sales transaction. When a typical local sales person interacts with a customer during a face-to-face transaction, that sales person often understands the local demographics, news and other matters important to the potential customers.

However, building this trust is challenging in today's environment of call centers that may be located some distance from the customers, often in different geographic regions. Many times, the sales people are not able to establish a good relationship with customers due in-part to their lack of understanding the local demographic, news and other cultural matters. These difficulties are compounded when service providers, like call centers, are located in low cost third world countries where the sales and customer service personnel may be unaware of the customer's culture and current events. Both customers and service provider operators, who may live in different cultures, may find it hard to communicate without anything common to discuss. This missing connection may cause the customer to feel a lack of personal element and the conversation may be short-lived leaving the customer feeling unsatisfied. In addition, with outsourcing viewed as a phenomenon that is transferring jobs to low wage regions and countries, customers may be hostile towards a service provider if the customer can determine that the provider is located off-shore.

What is needed is a sales tool that provides local demographic and other content relevant to customers, which can be used by sales and customer support personnel to steer the conversation in their favor, build trust and consummate a transaction with customer. This will also improve overall customer satisfaction.

### SUMMARY

The invention is designed to overcome a number of limitations in sales and customer support to provide an improved tool for relating to customers. An exemplary embodiment of a sales tool for improving customer service comprises a computer system including a processor, program, and network communication interface, wherein the computer system is configured to receive a geographic identifier, and configured to retrieve content relevant to the geographic identifier and provide the content to an operator, for example, sales personnel. In one embodiment, an identifier structure is capable of providing a geographic identifier to the computer system. In aspects of the invention, the geographic identifier is a zip code, a customer's telephone number where the geographic identifier is a geographic area corresponding to the telephone number, and a customer's internet address where the geographic identifier is a geographic area corresponding to the internet protocol address. In other aspects, the computer system is configured to retrieve content from internet databases relevant to the geographic identifier.

Advantages of the invention include the ability to provide improved sales and customer service.

### DRAWINGS

The invention is described with reference to the following figures.

FIG. 1 depicts an exemplary sales tool depicted as a computer system to aid an operator in performing sales, customer support, and other customer interaction services according to embodiments of the invention.

FIG. 2 depicts a network architecture according to an embodiment of the invention;

FIG. 3 is a flowchart showing steps performed by the method according to an embodiment of the invention.

### DETAILED DESCRIPTION

The invention is designed to overcome a number of limitations in sales, and customer support to provide an improved tool for relating to customers. The invention is particularly useful when a company employs sales and customer service personnel who are located at geographically distant locations from the customers.

While the invention is described with reference to specific apparatus and embodiments. Those skilled in the art will recognize that the description is for illustration and to provide the best mode of practicing the invention. Those skilled in the art will also recognize that variations and modifications can be made to the invention while remaining within the spirit of the claims. For example, while reference is made to a server including a database, the database can also reside on a different server and be accessed over a network. Also, while the preferred network is the Internet, any communication network can be used in the invention. Also, while reference is made to demographics, content and information, these terms are considered to be broadly defined to include customer attributes as well as geographical, cultural, local, news and other aspects. Likewise, while reference is made to a sales tool, the invention is broadly applicable to customer service, marketing and other aspects that involve customer interaction.

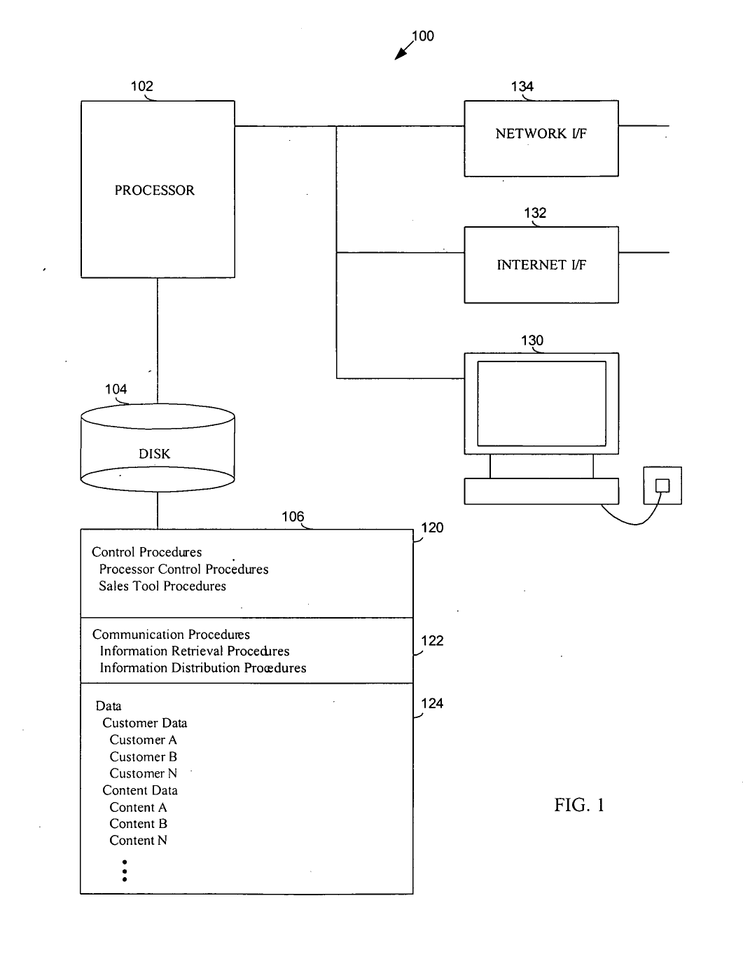

FIG. 1 depicts an exemplary sales tool depicted as a computer system 100 to aid an operator in performing sales, customer support, and other customer interaction services according to embodiments of the invention. The exemplary computer system includes a processor 102 and a storage device 104, for example, a disk drive. The storage device stores information 106 including control procedures and data for carrying out the invention. The server 100 further includes interfaces 132, 134 to communication with other networks and a user interface 130.

The invention is directed to a sales tool that is a system and method for improving sales/service-level by displaying customer-oriented content, including cultural, social, news and demographic data for a specific geographic location. The computer system storage 106 includes data 124 that can store, permanently or temporarily, customer data and content data. For example, the operator may be talking to a customer located in San Francisco, Calif. and the system will store this information in the customer data, for example, under customer A. The computer may then access a database, located locally or remotely, to retrieve content relevant to the customer data. The data particulars regarding each customer can be considered as customer attributes. For example, a customer in San Francisco, Calif. may have a number of attributes including their geographical location relevant to the customer. This information may be gathered on an initial call, or may be stored as customer data for later retrieval anytime when the customer calls the sales office. If the customer is a repeat customer, the tool can recall information associated with the customer, for example, age, family relationships and other information that may assist the operator in fulfilling the customer's request or even in selling additional goods or services to the customer.

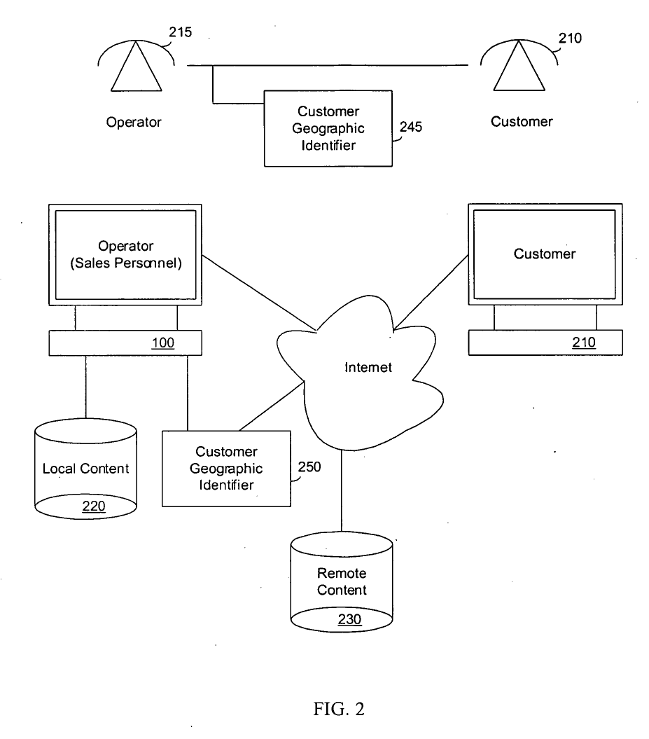

FIG. 2 depicts a network architecture according to an embodiment of the invention. One example of communication is over the telephone, for example, from a customer 210 to an operator 215. In this case, a customer geographic identifier structure 245 is provided in the form of a caller identification. Another embodiment is shown where the customer 210 communicates over the internet to an operator 100. In this case, a customer geographic identifier structure 250 can be provided to perform a reverse internet address lookup as explained below. In one aspect, the customer enters their geographic identifier directly into the system so no identifier structure is needed.

When a customer initiates contact with the call center, the contact may be made, for example, via phone, email, instant message or other technique. Once the call center receives the call, the invention obtains the caller's geographic identifier by one of several means. One option is a caller identification system, or caller-ID. This is provided either by a local structure or the telephone company. This information provides the full phone number including the area code and exchange, which can be used to quickly identify the geographic location of the caller. Another technique is an internet protocol address lookup which uses the caller's internet address as the source, similar to the caller-ID. With the internet address, the invention can use a reverse-lookup table either locally or from another database, e.g. an internet database, to ascertain the geographic identifier and provide the location of the caller. Yet another technique is to inquire information directly from the customer, for example, their zip code, telephone number, state or city that can be used to enter into the invention and retrieve content.

Referring to FIG. 2, the invention can include local content 220 that stores information locally, and remote content 230 that stores information remotely, for example, at a third party source. In one example, the content 230 includes news and other events relevant to the geographic locations of the customers. Typical content is weather, maps, area attractions, local/regional sports teams, live sports scores, demographic data, universities/colleges, news releases, local history, upcoming events/festivals, etc. Part of the data is stored in the data base, whereas some data is obtained real-time from other third party vendors.

Once the content is retrieved by the invention, the content is displayed for the operator to view and use during communication with customers. The information is collectively displayed real-time and enables operators to provide more effective communication in a informed personal manner with the customer. This personalization communication results in a better outcome for both the customer and the service provider, resulting in higher sales and service.

By displaying the regional/cultural information specific to the customer's location, the service provider is able to break the ice by communicating about local events/issues relevant to the customer. By being able to quickly “break the ice”, the service provider is able to get the customer more engaged, win some credibility/likeability and get the customers full attention resulting in a positive outcome (sale or satisfied customer). Having access to demographic information, like median income of households, can enable the agent to cross-sell customer appropriate products.

In the event that the customer is a new customer, the content is retrieved based on the customer data entered at the new time. In the event that the customer is a repeat customer, or one calling for customer service, the content can be retrieved based on the existing customer data.

Examples of interactions with customers include the following:

### EXAMPLE

It is the month of January. Detroit Lions beat the SF 49ers to win the Super Bowl. A customer, Phil Jackson, from a Detroit suburb of Troy, zip 48003 and/or area code (248) calls the sales center of a satellite TV retailer after hearing a direct response advertisement on radio. The 800 number is routed to a sales center in Gurgon, India. Here a young 21 year old sales associate with a heavy Indian accent answers the phone.

Scenario 1: (Without Invention)

“Thanks for calling ABC satellite, can I please have your zip code to check coverage for your home”.

“48003”

“Great we have satellite coverage. What promotion are you interested in?”

“What is your name? Where are you guys located?”

“Oh, my name is Jack and I am in India”.

“Jack?? In India . . . I thought this was a US company”

“Well it is sir, we are . . . ” - - - “click”<-customer hangup

Scenario 2: (With Invention)

“Thanks for calling ABC satellite, can I please have your zip code to check coverage for your home”.

“48003”

“Hmmm. . . . its cold out in Troy today Phil—Looks like more snow for the rest of the week?”

“Yes, this storm is pretty bad. I can't wait for the summer”

“Sure, do you like to visit Lake Michigan in the summers?”

“Yeah, we have a summer home and boat uptown on Lake Michigan”

“Great . . . well lets get started, I see your area has satellite coverage, what promotion are you interested in?”

Alternately during the long sales cycle the sales associate could break the ice by talking about the Lions Super Bowl victory or Baseball etc.

Clearly, by having real-time access to a customer's local geographic, cultural, social (entertainment) and demographic information, and other related content, a service provider has an impressive tool to steer the conversation his favor, resulting in a satisfied customer and a generally positive outcome.

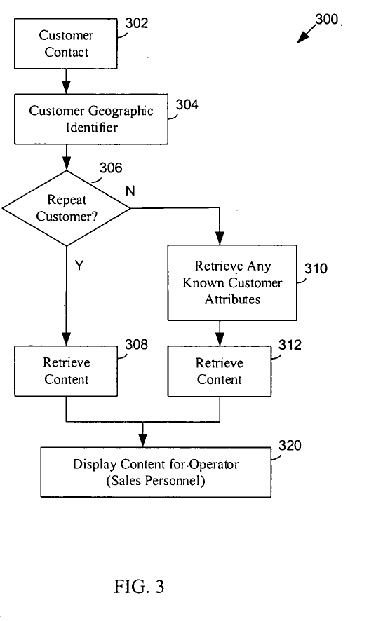

FIG. 3 is a flowchart 200 showing steps performed by the method according to an embodiment of the invention. In step 302, a customer contacts the call center. In step 304, the invention received a customer geographic identifier. If the invention is unable to obtain a satisfactory geographic identifier from an automated system, e.g. caller-ID or internet address lookup, the invention asks the caller to provide an identifier, e.g. a zip code or area code. In step 306, the invention queries whether the customer is a repeat customer, for example, to determine if the invention should retrieve prior sales information. If the customer is not a repeat customer, step 308 retrieves content based on the geographic identifier. If the customer is a repeat customer, step 310 retrieves any known customer attributes, e.g. prior sales and other information regarding the customer. Step 312 retrieves content based on the returning customer. In either event, step 320 displays the content for the operator to use in communicating with the customer.

Advantages of the invention include the ability to provide improved sales and customer service. The ability for operators to communicate with customers in their own language using references to demographic information, local events, news and other content that improves the sales experience for customers and has the potential to create more return customers.

Having disclosed exemplary embodiments and the best mode, modifications and variations may be made to the disclosed embodiments while remaining within the subject and spirit of the invention as defined by the following claims.

1. A sales tool for improving customer service, comprising:
a computer system including a processor, a program, and a network communication interface;
wherein the computer system is configured to receive a geographic identifier, and configured to retrieve content relevant to the geographic identifier and provide the content to an operator.

2. The sales tool of claim 1, further comprising:
an identifier structure capable of providing a geographic identifier to the computer system.

3. The sales tool of claim 1, wherein:
the geographic identifier is a zip code.

4. The sales tool of claim 2, wherein:
the identifier structure includes caller-ID configured to provide a customer's telephone number; and
the geographic identifier is a geographic area corresponding to the telephone number.

5. The sales tool of claim 2, wherein:
the identifier structure includes a reverse internet protocol address lookup configured to provide a customer's internet address; and
the geographic identifier is a geographic area corresponding to the internet protocol address.

6. The sales tool of claim 1, wherein:
the computer system is configured to retrieve content from internet databases relevant to the geographic identifier.

7. The sales tool of claim 2, wherein:
the computer system is configured to retrieve content from internet databases relevant to the geographic identifier.

8. The sales tool of claim 3, wherein:
the computer system is configured to retrieve content from internet databases relevant to the geographic identifier.

9. The sales tool of claim 4, wherein:
the computer system is configured to retrieve content from internet databases relevant to the geographic identifier.

10. The sales tool of claim 5, wherein:
the computer system is configured to retrieve content from internet databases relevant to the geographic identifier.

11. A method for improving customer service using a sales tool, comprising the steps of:
receiving a geographic identifier;
retrieving content relevant to the geographic identifier; and
providing the content to an operator.

12. The method claim 11, further comprising the step of:
providing a geographic identifier to the computer system.

13. The method claim 11, wherein:
the geographic identifier is a zip code.

14. The method claim 12, wherein:
the step of providing a geographic identifier includes providing a customer's telephone number; and
the geographic identifier is a geographic area corresponding to the telephone number.

15. The method claim 12, wherein:
the step of providing a geographic identifier includes providing a customer's internet address; and
the geographic identifier is a geographic area corresponding to the internet protocol address.

16. The method claim 11, wherein:
the step of retrieving information includes the step of retrieving content from internet databases relevant to the geographic identifier.

17. The method claim 12, wherein:
the step of retrieving information includes the step of retrieving content from internet databases relevant to the geographic identifier.

18. The method claim 13, wherein:
the step of retrieving information includes the step of retrieving content from internet databases relevant to the geographic identifier.

19. The method claim 14, wherein:
the step of retrieving information includes the step of retrieving content from internet databases relevant to the geographic identifier.

20. The method claim 15, wherein:
the step of retrieving information includes the step of retrieving content from internet databases relevant to the geographic identifier.
